(19) United States
(12) Patent Application Publication
(10) Pub. No.: US 2002/0010837 A1
(43) Pub. Date: Jan. 24, 2002

(54) Cache memory system and method of controlling cache memory

(76) Inventors: Nobuhisa Fujinami, Tokyo (JP); Ken Kurihara, Tokyo (JP)

Correspondence Address: William S. Frommer, Esq., FROMMER LAWRENCE & HAUG LLP, 745 Fifth Avenue, New York, NY, 10151, US

(21) Appl. No.: 09/883,667

(22) Filed: Jun. 18, 2001

(30) Foreign Application Priority Data
Jun. 19, 2000 (JP) 2000-182556

(51) Int. Cl. G06F 12/08

(52) U.S. Cl. 711/123; 711/144; 711/133; 711/143

(57) ABSTRACT

In order to maintain consistency between an instruction cache and a data cache and between the caches and a main memory, there is provided a cache memory system having a processor, a main memory, and a cache memory disposed between the processor and the main memory, which comprises an instruction cache for holding an instruction and a data cache for holding data, which comprises transferring means for transferring data directly from the data cache to the instruction cache; with which it is possible to exclude a time consuming processing such as access to the main memory, execution of a special instruction or the like.

### CROSS REFERENCES TO RELATED APPLICATIONS

The present document is based on Japanese Priority Document JP 2000-182556, filed in the Japanese Patent Office on Jun. 19, 2000, the entire contents of which being incorporated herein by reference.

### BACKGROUND OF THE INVENTION

1. Field of the Invention

The present invention relates to a cache memory system having a processor, a main memory unit, and a cache unit disposed between the processor and the main memory unit and for temporarily holding therein an instruction or data to be utilized by the processor. In particular, the present invention relates to a cache memory system in which the cache is composed of an instruction cache for holding an instruction and a data cache for holding data.

In more particularly, the present invention relates to a cache memory system having an instruction cache and a data cache, in which the data cache is operated based on a write-back method. In particular, the present invention relates to a technology for guaranteeing the consistency between a couple of caches and between the caches and the main memory when the processor writes the data into the main memory and thereafter the processor executes the data as a (part of) program.

2. Description of the Related Art

With the advancement of the current technology, various kinds of information processing systems are developed, and such kinds of information processing systems are widely deployed in many researching institutions, offices of firms, general families and so on. A fundamental architecture of such information processing system is comprised of a processor for executing the processing and a main memory for storing therein a set of program codes to be executed by the processor and working data being executed.

Recently, the clock rate of the processor is more and more increased, with the result that disparity tends to be enlarged between the clock rate under which the processor can be operated and the clock rate under which the main memory can be operated. For this reason, how the main memory is to be accessed at a high operation rate becomes a critical issue for executing an arithmetic operation or the like. In order to solve such issue, a memory unit, which is known as “cache”, having a small capacity but operable at a high rate is disposed between the processor and the main memory.

In an arrangement provided with the cache memory, if the processor finds a requesting data piece in the cache memory (i.e., cache hit), the processor utilizes the data piece stored in the cache memory in replace of the data piece stored in the main memory. That is, the processor is relieved from the duty for accessing the main memory which can be operated at a low rate, and hence the speed for the processor to access the data can be improved upon cache hit. On the other hand, if the processor fails to find the requesting data piece in the cache memory (i.e., cache miss), the processor accesses the main memory to read the desired data piece and writes the data piece into the cache memory. Further, if the cache memory is already filled with other data, the processor replaces a part of the cache memory contents with the desired data piece. As a manner for replacing the data piece, there can be introduced a method based on the data using frequency such as the LRU (Least Recently Used) in which the desired data is replaced for data of which last referred timing is the oldest one, for example.

The technology of caching is based on the principle of locality of programs or data. The effect of caching is represented by “hit ratio”, for example. If the hit ratio is described with simple terms, as the capacity of the cache memory is increased, the hit ratio is also improved. Furthermore, the hit ratio is influenced by an algorism for replacing data in the cache memory with other data.

When the data stored in the cache memory is replaced with the other data, in order to maintain the consistency with the main memory, the contents of the main memory shall be dynamically updated by means of the data rewriting operation. In this case, there can be introduced a write-back method and a write-through method as a method for reflecting the replaced contents on the main memory. According to the write-back method, when the processor executes a writing operation, the data of the writing operation is written only in the cache memory but not in the main memory. When a line corresponding to the data rewriting on the cache memory is exchanged, the rewriting data is written into the main memory. Conversely, according to the write-through method, when the processor executes a writing operation, the data of the writing operation is written one by one in both of the cache memory and the main memory. In general, using frequency of a bus is lower in the write-back method than in the write-through method. Therefore, it is said that the write-back method is more advantageous than the write-through method in terms of system performance.

Further, in general, the cache memory is composed of an instruction cache for holding therein an instruction and a data cache for holding therein data. That is, an instruction read from the main memory by the processor is written into the instruction cache while data read from the main memory by the processor is written into the data cache. This is because instructions and data are different from each other in nature such as using frequency. Therefore, if instructions and data are stored in separate cache memories, respectively, and managed independently, the rewriting operation of the cache memory can be more effectively carried out.

Meanwhile, when ordinary processing operation is carried out in a computer system, there is a case where data written into the main memory by the processor are thereafter executed as a (part of) program. For example, when a program is loaded in the main memory or libraries are dynamically linked with one another, such a case where the data written into the main memory by the processor are thereafter executed as a (part of) program is caused.

If the cache memory system is provided with an instruction cache and a data cache so that they are independent from each other, and the write-back method is employed with regard to the caching on the data cache, a complicated processing is requested for maintaining the consistency between the couple of caches and between the cache memory and the main memory.

The following is an example of a self-modifying type program code set executed on a 8086-type processor or a processor succeeding that processor supplied by Intel Corporation in the U.S. The following set of codes describes a processing scheme of CX-pieces of word data read from a memory denoted as SI and CX-pieces of word data read from a memory denoted as DI, wherein addition is executed if AL takes a value of zero while subtraction is executed if AL takes any value other than zero.

MOV BYTE PTR TARGET, 01H; (01H represents a machine code of ADD command)

TEST AL, AL

JZ L1

MOV BYTE PTR TARGET, 29H; (29H represents a machine code of SUB command)

L1: MOV AX, [S1]

ADD SI,2

TARGET: ADD [D1], AX

ADD D1,2

DEC CX

JNZ L1

When such a self-modifying type program code described above is executed, if the cache memory utilized by the processor does not have a mechanism for maintaining consistency between the data cache and the instruction cache (or further instruction fetch result), there is a possibility that the system can be operated in a manner which is unpredictable based on the program.

The problem of consistency has been solved so far by either of the following two schemes identified by (1) and (2), for example.

(1) When a writing operation is brought about on memory contents having been written in the instruction cache and having undergone decoding operation, this fact is detected by the processor automatically, the contents rewritten in the data cache is again written in the main memory, and corresponding contents in the instruction cache or the decoded contents are made invalid.

The above-described scheme is employed in an x86 type processor supplied by Intel Corporation, for example.

A specification of U.S. Pat. No. 5,835,949 (method of identifying and self-modifying code) discloses a technology for creating a circuit for erasing a rewritten instruction from a pipeline under execution at a low cost.

A specification of U.S. Pat. No. 5,826,073 (self-modifying code handling system) discloses a system for generating a fault message when writing operation is performed on the data stored in an instruction cache.

A specification of U.S. Pat. No. 5,649,137 (method and apparatus for store-into-instruction-system detection and maintaining branch prediction cache consistency) discloses a method of carrying out invalidation on a branch prediction cache (instruction of a branch is cached in advance) in addition to an instruction cache, when data is written.

A specification of U.S. Pat. No. 5,214,770 (system for flushing instruction-cache only when instruction-cache address and data-cache address are matched and the execution of a return-from-execution-or-interrupt command) discloses a method in which when data is written in a data cache, a flag is set on an instruction cache having a coincident address and contents are flashed when the processing returns from an interruption process or an exception process.

(2) A program under operation or an operating system (OS) is made to use a special instruction for controlling a cache memory so that the contents of the instruction cache is updated correctly.

The above-scheme is widely employed in an RISC (Reduced Instruction Set Computer) type processor, for example.

According to the above scheme, in a simple implementation, the processor of the system uses an instruction for flashing the cache memory to flash both of the instruction cache and the data cache so that the processor is forced to read correct contents from the main memory.

A specification of U.S. Pat. No. 5,909,698 (cache block store instruction operations where cache coherency is achieved without writing all the way back to main memory) discloses an improved version of the above method in which the operation of the instruction for flashing the cache memory is modified. That is, in all cases except for when a multiprocessor or the like necessitates, data is not rewritten in the main memory and only an instruction cache having a coincident address is updated.

According to the above-described conventional technologies, it is true that the issue regarding the data consistency between the cache memory and the main memory can be solved. However, except for the method disclosed in the specification of U.S. Pat. No. 5,909,698, considerable amount of time cost is required.

Further, as for the method regarding the specification of U.S. Pat. No. 5,909,698, there is a problem that the instruction for controlling the cache memory is privileged instruction (instruction allowable to be used only by the operating system) in almost all processors. That is, when a corresponding function is utilized from a user program, it is necessary for the operating system to support the execution of the function, which fact further necessitates the time cost.

The above methods have been employed in spite of the fact that they are relatively time consuming. This fact is based on an analysis. That is, the situation in which the problem of consistency between the couple of cache memories becomes serious is extremely rare as compared with an ordinary program execution.

However, recently, a technology is actively utilized that, during the execution of a program, another program is written in a memory and executed, such as those known as “binary translation”, “just-in-time compilation” or the like. For this reason, a situation is brought about at a considerably high frequency in which to maintain consistency between the couple of cache memories seriously matters. That is, it is considered that the cost in terms of time for maintaining the consistency between the couple of cache memories causes a considerable level of lowering of execution speed of a program.

A specification of U.S. Pat. No. 4,701,844 (dual cache for independent prefetch and execution units) discloses a method useful in a case where the data cache employs not the write-back method but the write-through method. According to this method, when a piece of data is written in the main memory, if the data piece is already present in the instruction cache or the data cache, the corresponding data of the instruction cache or the data cache is updated.

However, almost all processors currently available employ the write-back method on the data cache. Thus, the above method disclosed in the above-introduced USP. cannot be applied directly.

Therefore, it is an object of the present invention to provide an excellent cache memory system in which the cache memory is composed of an instruction cache for holding an instruction and a data cache for holding data, and the write-back method is employed for caching data.

Another object of the present invention is to provide an excellent cache memory system which can guarantee the consistency between a couple of caches and between the caches and the main memory when the processor writes the data into the main memory and thereafter the processor executes the data as a (part of) program.

### SUMMARY OF THE INVENTION

The present invention seeks to solve the above problems. According to a first aspect of the present invention, there is provided a cache memory system having a processor, a main memory unit, and a cache memory disposed between the processor and the main memory, which comprises an instruction cache for holding an instruction and a data cache for holding data. The cache memory system is arranged to include transferring means for transferring data directly from the data cache to the instruction cache.

According to a second aspect of the present invention, there is provided a cache memory system having a processor, a main memory unit, and a cache memory disposed between the processor and the main memory, which comprises an instruction cache for holding an instruction and a data cache for holding data. The cache memory system is arranged to include determining means for determining whether or not the processor hits an instruction held in the instruction cache upon writing data, and invalidating means for invalidating the corresponding portion held in the instruction cache in response to the fact that the processor hits the instruction held in the instruction cache upon writing data.

According to a third aspect of the present invention, there is provided a cache memory system having a processor, a main memory unit, and a cache memory disposed between the processor and the main memory, which comprises an instruction cache for holding an instruction and a data cache for holding data. The cache memory system is arranged to include first determining means for determining whether or not the processor hits an instruction held in the instruction cache upon reading out an instruction, second determining means for determining whether or not the processor hits an instruction as a target of reading held in the data cache, in response to a fact that the processor fails to hit the instruction as a target of reading held in the instruction cache, and transferring means for transferring the instruction as a target of reading directly from the data cache to the instruction cache, in response to the fact that the processor hits the instruction held in the data cache.

According to a fourth aspect of the present invention, there is proposed a method of controlling a cache memory disposed between a processor and a main memory unit, which comprises an instruction cache for holding an instruction and a data cache for holding data, wherein the method is arranged to include a step of transferring data directly from the data cache to the instruction cache.

According to a fifth aspect of the present invention, there is proposed a method of controlling a cache memory disposed between a processor and a main memory unit, which comprises an instruction cache for holding an instruction and a data cache for holding data, wherein the method is arranged to include a step of determining whether or not the processor hits an instruction held in the instruction cache upon writing data; and a step of invalidating the corresponding portion held in the instruction cache in response to a fact that the processor hits the instruction held in the instruction cache upon writing data.

According to a sixth aspect of the present invention, there is proposed a method of controlling a cache memory disposed between a processor and a main memory unit, which comprises an instruction cache for holding an instruction and a data cache for holding data, both of the caches being disposed between the processor and the main memory unit, wherein the method is arranged to include a first step of determining whether or not the processor hits an instruction held in the instruction cache upon reading an instruction; a second step of determining whether or not the processor hits an instruction as a target of reading held in the data cache, in response to a fact that the processor fails to hit the instruction as a target of reading held in the instruction cache; and a step of transferring the instruction as a target of reading directly from the data cache to the instruction cache, in response to a fact that the processor hits the instruction held in the data cache.

As described above, according to the present invention, there can be provided an excellent cache memory system in which the cache memory is composed of an instruction cache for holding an instruction and a data cache for holding data, and the write-back method is employed for caching data.

Further, according to the present invention, there can be provided an excellent cache memory system which can guarantee the consistency between the couple of caches and between the caches and the main memory when the processor writes the data into the main memory and thereafter the processor executes the data as a (part of) program.

According to the conventional technology for maintaining the consistency between a couple of caches and between the caches and a main memory, it is necessary to automatically detect whether the data written by the processor is present or not in the instruction cache. In this way, the contents of the data cache are once written in the main memory and again the data are taken into the instruction cache. Alternatively, an instruction for controlling the cache memory shall be executed on the program base.

By contrast, according to the arrangement of the present invention, when the processor carries out a writing operation, the contents of the instruction cache are automatically updated before the instruction is executed. Thus, the contents of the instruction cache can be always made equal to the last value stored in the main memory or the data cache.

For example, in a case where the data written by the processor is frequently requested to execute as an instruction, the possibility that the written data is present in the data cache becomes high. Therefore, if the contents are transferred from the data cache not by way of the main memory but directly to the instruction cache, then the processing can be executed at high speed.

That is, according to the present invention, it becomes possible to exclude a time consuming processing such as access to the main memory, execution of a special instruction or the like.

According to the present invention, it becomes possible to effect at a high speed a virtual machine employing a program which includes a step of executing data written by the processor as an instruction such as just-in-time compilation or the like, for example. Moreover, the advantage of the present invention is not confined to the fact that the processing speed becomes high. That is, the following advantages can be further obtained.

(1) It becomes possible to shorten the necessary time period it takes from the data writing to the execution of the data as an instruction. Therefore, the execution time at the worst case can also be shortened.

(2) A useless number of accesses to the main memory can be decreased. Thus, negative influence upon other process or the processor can be suppressed to the minimum level.

(3) It is unnecessary to prepare a special instruction for executing the scheme of the present invention. Therefore, a program can be developed with ease.

The above and other objects, features and advantages of the present invention will become apparent from the following description of embodiments of the present invention which will be made with reference to the accompanying drawings.

### BRIEF DESCRIPTION OF THE DRAWINGS

FIG. 1 is a diagram schematically showing an arrangement of a cache memory system as an embodiment of the present invention;

FIG. 2 is a timing chart showing operation timings for writing instruction data in an instruction cache of the cache memory system as the present embodiment;

FIG. 3 is a timing chart showing operation timings when an instruction cache miss is brought about in the cache memory system as the present embodiment;

FIG. 4 is a timing chart showing operation timings for writing instruction data in an instruction cache of a cache memory system based on a conventional technology; and

FIG. 5 is a timing chart showing operation timings when an instruction cache miss is brought about in the cache memory system based on the conventional technology.

### DETAILED DESCRIPTION OF PREFERRED EMBODIMENTS

Embodiments of the present invention will be hereinafter described with reference to the drawings.

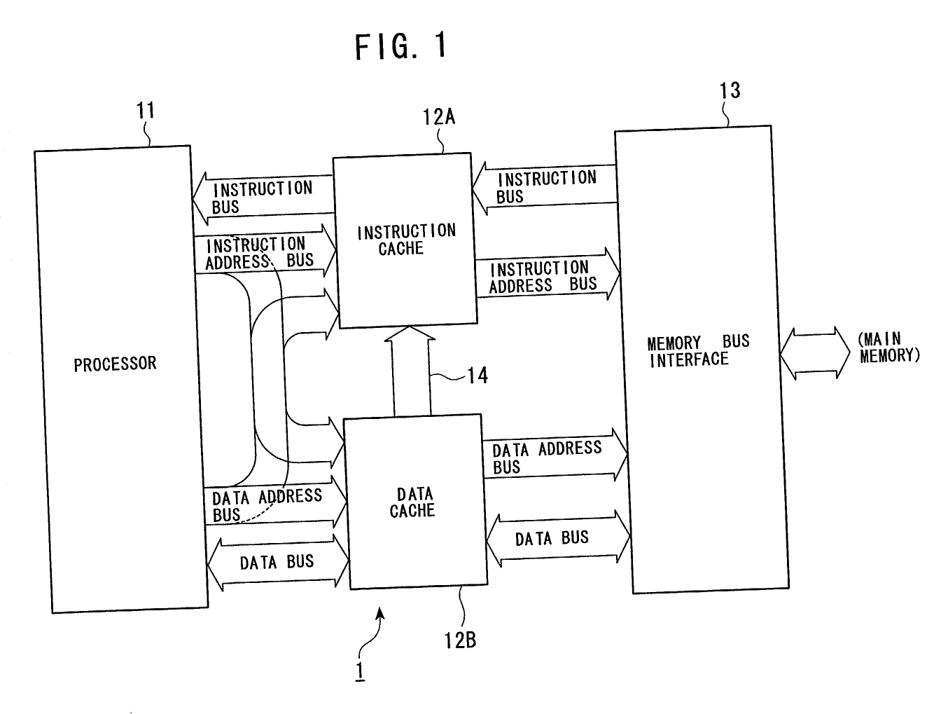

FIG. 1 is a diagram schematically showing an arrangement of the cache memory system 1 as an embodiment of the present invention. As shown in FIG. 1, the cache memory system 1 is arranged to include a processor 11 for executing processing, a memory bus interface unit 13 serving as an interface with a main memory in which program codes to be executed by the processor 11 and working data under execution are stored, and a cache memory 12 disposed between the processor 11 and the main memory so that the cache memory 12 can absorb the difference in memory access speed.

If a data piece requested (i.e., data piece whose address is designated) by the processor 11 is present in the cache memory 12 (this situation is hereinafter referred to as “cache hit”), the processor 11 utilizes the data piece in the cache memory 12 instead of the corresponding one in the main memory. That is, the processor 11 can be relieved from access operation to the main memory which unavoidably is operated at a low speed, the data access can be achieved at a high speed if the processor 11 successfully hits the requesting data piece. Conversely, if the requesting data piece is not present in the cache memory 12 (this situation is hereinafter referred to as “cache miss”), the processor 11 accesses the main memory to read the desired data piece and writes the data piece in the cache memory 12.

As shown in FIG. 1, the cache memory 12 is composed of an instruction cache 12A and a data cache 12B independent from each other. The data cache 12B employs a write-back method. Therefore, when the processor 11 carries out a writing operation, the processor 11 writes the data in only the cache memory 12 but not in the main memory. When a corresponding line is replaced in the cache memory 12, the replacing data is written in the main memory.

According to the present embodiment, the cache memory 12 is arranged to serve as a “level-1” cache placed closest to the processor 11. However, if the cache memory system is arranged to include a plurality of cache memory units each functioning at a different level and a cache memory of level-2 or lower level is an instruction/data integrated type cache, then the main memory can be regarded as the level-2 cache. In this way, the above arrangement can be regarded as a cache memory system having the same construction and providing the same effect or advantage as that of the present invention.

The processor 11 and the instruction cache 12A are interconnected to each other through an instruction bus and an instruction address bus. Further, the instruction cache 12A and the memory bus interface 13 are interconnected to each other through an instruction bus and an instruction address bus.

The processor 11 sends the corresponding address on the instruction address bus so as to request the instruction from the instruction cache 12A by caching. In response to the caching request, if the corresponding instruction is stored in the instruction cache 12A (i.e., in a case of cache hit), the instruction cache 12A supplies the corresponding instruction to the processor 11 through the instruction bus. Conversely, if the corresponding instruction is not stored in the instruction cache 12A (i.e., in a case of cache miss), the instruction cache 12A further sends the corresponding address to the memory bus interface 13 through the instruction address bus. Thus, the instruction is requested from the main memory.

The processor 11 and the data cache 12B are interconnected to each other through a data bus and a data address bus. The data cache 12B and the memory bus interface 13 are also interconnected to each other through a data bus and a data address bus.

When the processor 11 tries to write or read out data, the processor 11 sends a corresponding address on the data address bus. Thus, the processor 11 requests a data writing or a data reading on the data cache 12B. In response to the request, if the corresponding data is stored in the data cache 12B, (i.e., in the case of cache hit), the data cache 12B carries out the operation of data writing or data reading on the data cache 12B. (In this case, the so-called write-back method is employed. Therefore, when the operation executed by the processor 11 is the writing operation, the data is written only in the cache memory but not in the main memory. When a corresponding line is replaced in the data cache 12B, the replacing data is written in the main memory.) Conversely, if the corresponding data is not stored in the data cache 12B (i.e., in the case of cache miss), the data cache 12B further sends the corresponding address to the memory bus interface 13 through the data address bus. Thus, the data is requested to the main memory.

According to the cache memory system 1 of the present embodiment, the instruction address bus extending from the processor 11 is connected not only to the instruction cache 12A but also to the data cache 12B. Similarly, the data address bus extending from the processor 11 is connected not only to the data cache 12B but also to the instruction cache 12A.

The data cache 12B is provided with a data transfer bus 14 for sending data to the instruction cache 12A. Therefore, when the processor 11 writes data in the data cache 12B and thereafter this data is executed as a (part of) program, the instruction cache 12A is allowed to read directly from the data cache 12B through the data transfer bus 14. Accordingly, it becomes possible to obviate the time consuming processing such as processing of access to the main memory or the like.

According to the present invention, the contents of the instruction cache 12A always becomes equal to the value last stored in the main memory or the data cache 12B. Further, if the processor is frequently obliged to execute the written data as an instruction, the possibility that the written data is present in the data cache 12B becomes high. Therefore, the possibility that a high speed data access scheme, i.e., the contents are transferred from the data cache 12B to the instruction cache 12A without passing through the main memory, is selected becomes high.

The operation characteristic of the cache memory system 1 as the embodiment of the present invention will be hereinafter described.

Initially, the operation characteristic of the cache memory system 1 when the processor 11 executes an instruction for writing data in the main memory will be discussed.

An ordinary operation of the write-back method is as follows. That is, if a data piece as a target of writing operation is stored in the data cache 12B, this data piece is written in the data cache 12B, and a flag is settled so as to indicate that a cache block including the target of the writing operation has been subjected to a writing operation (i.e., the cache block is placed in a “dirty” state). The contents of the cache block placed in the “dirty” state is again written in the main memory upon necessity.

Conversely, if the data cache miss mode is brought about, several schemes are prepared in the write-back method. In one of the schemes, the target as the writing operation is simply written in the main memory. Alternatively, data pertinent to the target data is read from the main memory so that a complete form of cache block containing the target of the writing operation is prepared, and this complete form of cache block is utilized for effecting the operation similar to that in the data cache hit mode.

According to the arrangement of the present embodiment, when the processor 11 hits the target of writing operation in the instruction cache 12A, the corresponding portion in the instruction cache 12A is made invalid. At this time, new contents may be written in the instruction cache 12A. (However, if the employed write-back method is such one that the target of the writing operation is read from the main memory in response to the data cache miss upon the writing operation, the corresponding portion will be taken into the instruction cache immediately. Therefore, the invalidating operation is not very much necessary.)

Further, if the contents of the main memory have been already supplied to a prefetch unit, a decode unit or the like, the supplied contents are made invalid and new contents are supplied.

The operation characteristic of the cache memory system 1 when the instruction cache miss is brought about will be hereinafter discussed.

As an ordinary operation, the instruction cache 12A reads an instruction from the main memory so that the corresponding cache block is completely filled with data.

According to the arrangement of the present embodiment, the instruction cache 12A reads data from the main memory only when the target of reading operation is not present in the data cache 12B. If there is the corresponding instruction in the data cache 12B, the contents thereof are transferred from the data cache 12B to the instruction cache 12A.

Operation carried out when the processor 11 executes the instruction for the processor to read data from the main memory or operation carried out by the cache memory system 1 upon instruction cache hit may follow the conventional scheme.

Now, discussion will be made on comparison between the operation characteristics of the cache memory system 1 according to the present embodiment and that of the conventional one when the instruction cache miss is brought about.

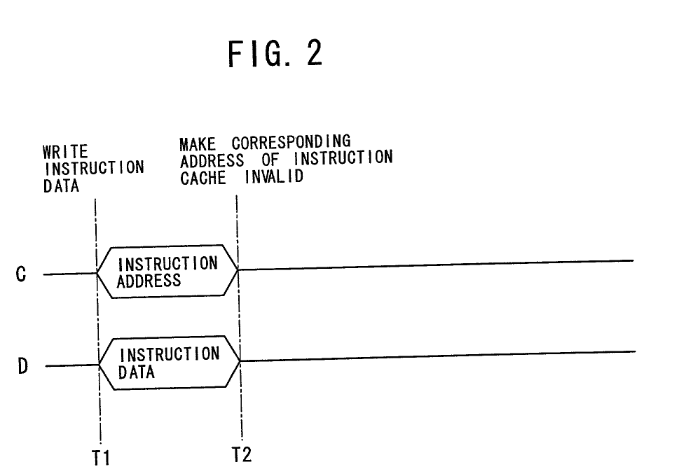

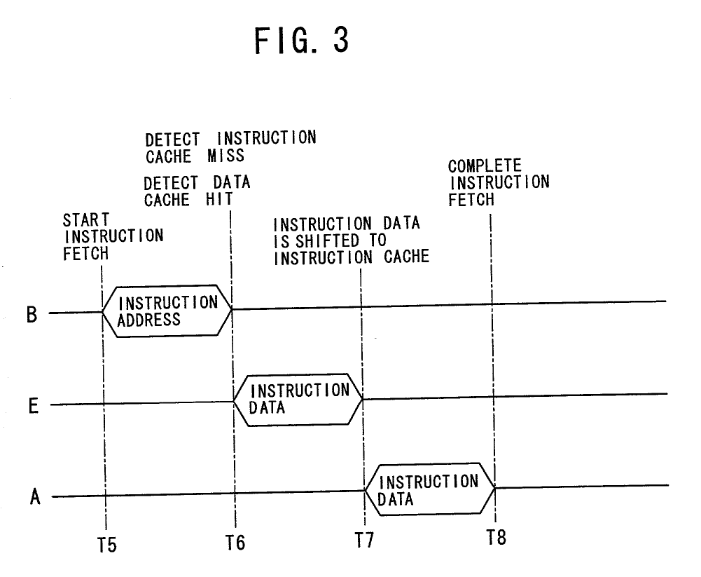

FIG. 2 is a timing chart illustrating operation timings when the cache memory system 1 according to the present embodiment writes instruction data. FIG. 3 is a timing chart illustrating operation timings when the cache memory system 1 according to the present embodiment encounters cache miss upon fetching an instruction.

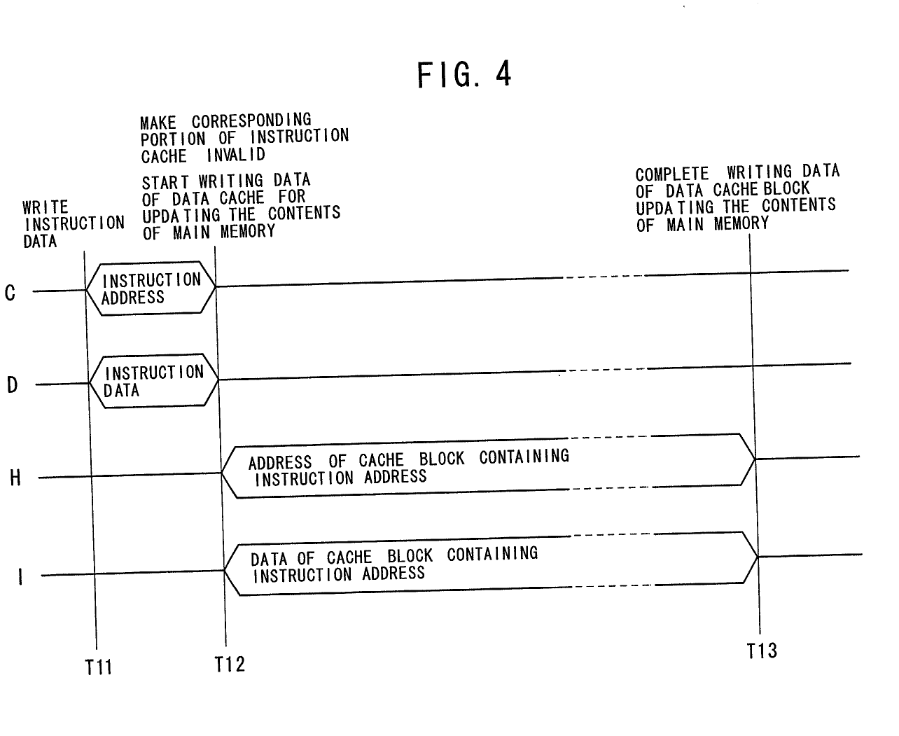

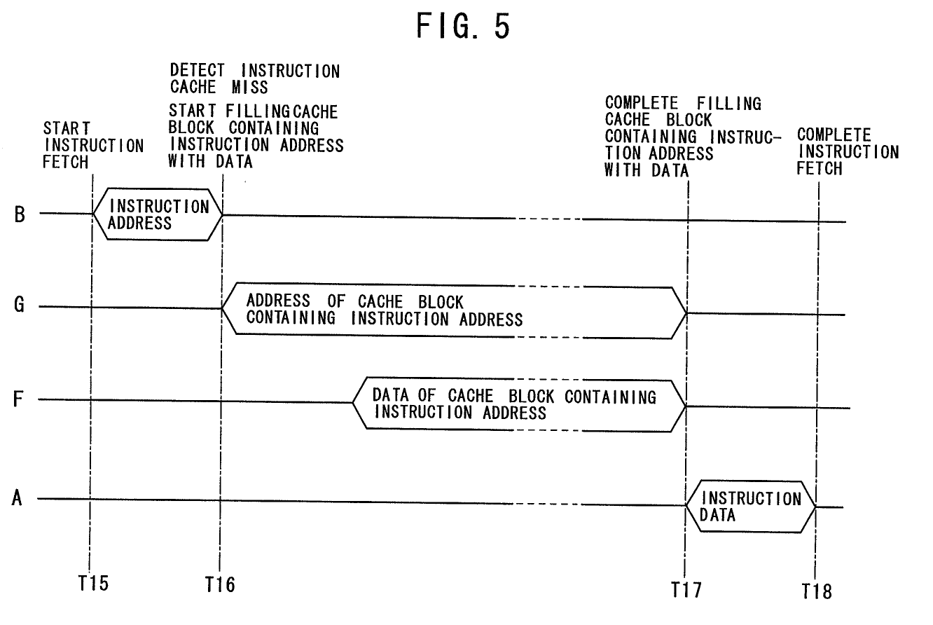

FIGS. 4 and 5 are provided so that comparison can be made between the operation timings of the present embodiment and those of the conventional technology. That is, FIG. 4 is a timing chart illustrating operation timings when a cache memory system based on the conventional technology writes instruction data. FIG. 5 is a timing chart illustrating operation timings when the cache memory system 1 based on the conventional technology suffers from cache miss upon fetching an instruction.

In each of the diagrams, reference symbols A, B, C and D represent signal lines extending from the processor 11 to the caches (i.e., they represent instruction bus, instruction address bus, data address bus, data bus, respectively), E represents a signal line extending from the data cache 12B to the instruction cache 12A, and F, G, H and I represent signal lines extending from the caches to the memory bus interface 13 (i.e., they represent instruction bus, instruction address bus, data address bus data bus, respectively).

Initially, when the processor 11 writes an instruction data in the memory, according to the cache memory system 1 of the present embodiment, as shown in FIG. 2, the processor 11 generates an address and data of the instruction as a target of the writing operation at timing point T1, whereby the contents are written in the data cache 12B.

If the processor 11 hits the target of writing operation in the instruction cache 12A, at timing point T2 when the instruction address and the instruction data are completely generated, the corresponding address of the instruction cache 12A is made invalid and the processing is finished.

Conversely, in the cache memory system based on the conventional technology, as shown in FIG. 4, at timing point T11, the processor generates an address and data of the instruction as a target of the writing operation, whereby the contents are written in the data cache. If the processor hits the target of writing operation in the instruction cache, at timing point T12 when the instruction address and the instruction data are completely generated, the processor is obliged to generate an address of a cache block containing the instruction address and data of the cache block containing the instruction address to the memory bus interface so that the corresponding portion of the instruction cache is made invalid and the writing is effected on the main memory for updating the memory contents. At timing point T13, the contents of the data cache are completely written for updating the main memory. In this way, the processing is finished.

In general, it takes several times time period to several tens times time period for memory accesses, such as a write operation from the cache memory to the main memory or a read out operation from the main memory to the cache memory, as compared with the reading and writing operation effected exclusively on the cache memory. Therefore, timing point T13 when the instruction data writing is completed in the conventional technology delays much more as compared with timing point T2 when the instruction data writing is completed in the present embodiment.

Now, discussion will be made on comparison between the operation carried out in the cache memory system according to the present embodiment and that based on the conventional technology when the instruction cache miss is brought about.

According to the cache memory system 1 of the present embodiment, as shown in FIG. 3, at timing point T5, the processor 11 generates an address of an instruction as a target of the reading operation so that instruction fetch is effected. At timing point T6, the instruction cache miss and data cache hit (i.e., a required instruction is present in the data cache as a data piece) are detected. In this case, the instruction data having a designated address is transferred from the data cache 12B to the instruction cache 12A through the data transfer bus 14 (at timing point T7). The instruction fetch operation is finished at timing point T8 when the instruction data is completely transferred to the processor 11.

By contrast, according to the cache memory system based on the conventional technology, as shown in FIG. 5, at timing point T15, the processor generates an address of an instruction as a target of the reading operation so that instruction fetch is effected. At timing point T16, the processor detects the instruction cache miss. Then, an address of a cache block containing the instruction address is sent to the memory bus interface so as to start instruction cache fill. In this way, data of the cache block containing the instruction address can be received.

In general, it takes several times time period to several tens times time period for the memory accesses, such as a write operation from the cache memory to the main memory or a read out operation from the main memory to the cache memory, as compared with the reading and writing operation effected exclusively on the cache memory. Therefore, it takes a lot of time for instruction cache fill.

At timing point T17, the instruction cache fill is completed. When the instruction data is transferred to the processor at timing point T18, the instruction fetch operation is completed.

In general, the instruction cache fill requires a plural number of access trials (if the processor is such a type of one that the instruction can be read from the cache at timing point when the processor accesses a memory corresponding to the instruction address, the timing when the instruction fetch operation is finished becomes slightly earlier).

The present invention has been described in detail with reference to specific embodiments. However, it should be understood that those skilled in the art could effect various modifications or substitutions of the above embodiments without departing from the gist of the present invention. That is, the above embodiments or examples are for illustrative purpose only and therefore they shall not be interpreted restrictively. The scope or spirit of the present invention shall be interpreted based on the appended claims.

What is claimed is:

1. A cache memory system having a processor, a main memory, and a cache memory disposed between the processor and the main memory, which comprises an instruction cache for holding an instruction and a data cache for holding data, said cache memory system comprising:
transferring means for transferring data directly from said data cache to said instruction cache.

2. A cache memory system having a processor, a main memory, and a cache memory disposed between the processor and the main memory, which comprises an instruction cache for holding an instruction and a data cache for holding data, said cache memory system comprising:
determining means for determining whether or not said processor hits an instruction held in said instruction cache upon writing data; and
invalidating means for invalidating a corresponding portion held in said instruction cache in response to a fact that said processor hits the instruction held in said instruction cache upon writing data.

3. A cache memory system having a processor, a main memory, and a cache memory disposed between the processor and the main memory, which comprises an instruction cache for holding an instruction and a data cache for holding data, said cache memory system comprising:
first determining means for determining whether or not the processor hits an instruction held in said instruction cache upon reading an instruction;
second determining means for determining whether or not said processor hits an instruction as a target of reading held in said data cache, in response to a fact that said processor fails to hit the instruction as a target of reading held in said instruction cache; and
transferring means for transferring the instruction as a target of reading directly from said data cache to said instruction cache, in response to a fact that said processor hits the instruction held in said data cache.

4. A method of controlling a cache memory disposed between a processor and a main memory, which comprises an instruction cache for holding an instruction and a data cache for holding data, said method comprising:
a step of transferring data directly from the data cache to the instruction cache.

5. A method of controlling a cache memory disposed between a processor and a main memory, which comprises an instruction cache for holding an instruction, and a data cache for holding data, said method comprising:
a step of determining whether or not said processor hits an instruction held in said instruction cache upon writing data; and
a step of invalidating a corresponding portion held in said instruction cache in response to a fact that said processor hits the instruction held in said instruction cache upon writing data.

6. A method of controlling a cache memory disposed between a processor and a main memory, which comprises an instruction cache for holding an instruction and a data cache for holding data, the method comprising:
a first step of determining whether or not said processor hits an instruction held in said instruction cache upon reading an instruction;
a second step of determining whether or not said processor hits an instruction as a target of reading held in said data cache, in response to a fact that said processor fails to hit the instruction as a target of reading held in said instruction cache; and
a step of transferring the instruction as a target of reading directly from said data cache to said instruction cache, in response to a fact that said processor hits the instruction held in said data cache.
